(19) United States
(12) Patent Application Publication
(10) Pub. No.: US 2011/0286866 A1
(43) Pub. Date: Nov. 24, 2011

(54) AC Power Unit Operating System For Emergency Vehicles

(76) Inventor: Leonard H. Hancock, SR., Hummelstown, PA (US)

(21) Appl. No.: 13/090,355

(22) Filed: Apr. 20, 2011

Related U.S. Application Data
(60) Provisional application No. 61/325,836, filed on Apr. 20, 2010.

(51) Int. Cl. F04B 35/04; B60L 1/00

(52) U.S. Cl. 417/410.1; 307/9.1

(57) ABSTRACT

An AC operating system has an electrical distribution panel; a variable frequency drive control unit having a first variable frequency drive and a second variable frequency drive; a hydraulic oil heat exchanger; and a hydraulic power unit. The hydraulic power unit includes a housing having a first electric motor connected to the first variable frequency drive and a second electric motor connected to the second variable frequency drive. A first pump and valve assembly is connected to the first electric motor and a second pump and valve assembly is connected to the second electric motor. A motor start command is transmitted from the electrical distribution panel to at least one of the variable frequency drives. The variable frequency drive controller ramps up power to the selected motor to begin rotation of the motor to a predetermined operating speed in a predetermined amount of time.

### CROSS REFERENCE TO RELATED APPLICATION

This application claims priority to U.S. Provisional Application No. 61/325,836, filed Apr. 20, 2010, which is herein incorporated by reference in its entirety.

### BACKGROUND OF THE INVENTION

1. Field of the Invention

This invention relates generally to AC powered hydraulic circuits and, more particularly, to a system for the simultaneous operation of multiple hydraulic tools for an emergency vehicle.

2. Technical Considerations

Various types of emergency vehicles are in use today. These emergency vehicles include large, heavy duty vehicles, such as, fire engines and the like and smaller vehicles used principally as first response vehicles in the event of an accident or other emergency. With either type of vehicle, the vehicle typically includes a hydraulic circuit for the operation of hydraulically powered rescue tools, such as spreaders, cutters, saws, and the like. It is not uncommon for two different types of emergency tools to be operated at the same time.

In some emergency vehicles, an alternating current (AC) generator provides the power to operate the electric motors of the hydraulic circuit and the valves that supply hydraulic fluid to the emergency tools. These generators also supply power to other electrically operated equipment, such as lights. These electric generators are typically made for permanent installation on the vehicle. Conventional generators can be in the range of 25 kilowatts to 40 kilowatts output capacity, with some generators being as large as 80 kilowatt output capacity. However, the larger the kilowatt output capacity, the larger and heavier the generator must be. In hydraulic systems, the power relates to the flow rate and the operating pressure of the system. Therefore, larger electric motors can increase the power of the hydraulic circuit. However, the larger the electric motor the more electric power is required to operate the motor and the larger the AC generator required.

A problem with these known systems is not the AC power required to run the electric motor but rather the power required to start the electric motor. For example, once the hydraulic system is up and running, the electric motor for a particular hydraulic circuit may only require about 7 kilowatts to operate. Therefore, conventional generators on the order of 25 kilowatts to 40 kilowatts typically have no problem maintaining these motors in operation as well as accounting for the other electrical demands. However, while an electric motor may only require 4 kilowatts during operation, starting the motor requires a much larger “in-rush” current to get the motor turning and up to operational speed. It is not uncommon for such in-rush currents to be on the order of four to five times the maximum current which is required during operation once the motor has reached operating speed. Therefore, for a conventional 25 kilowatt generator, if other electrical users are in operation, such as lights, there may not be sufficient current available to compensate for the in-rush current to initially start multiple motors in the hydraulic system. If there is insufficient current to start the motors but the start button on the motors is pushed anyway, the generator can go over its current capacity and can shutdown. This would be an undesirable effect, particularly in an emergency situation. By eliminating this in-rush current, higher capacity power output motors can be utilized to provide greater operational power to the tools in the form of higher pump flow outputs at operational pressures.

Further, since electric motors generate heat while in operation, conventionally designed air cooled motors require a supply of free air flow over the motor windings in adequate volume to maintain a proper operating temperature. A motor failure will occur if the motor is not sufficiently cooled. This requirement greatly restricts the mounting position of a motor-driven hydraulic power unit on a rescue vehicle since the majority of mounting space provided is within closed body compartments or chassis locations.

Therefore, it would be desirable to provide an AC power unit operating system for an emergency vehicle capable of operating at least two hydraulic motors for two independent emergency tools that overcomes the shortcomings discussed above.

### SUMMARY OF THE INVENTION

A method of operating an AC power unit operating system for an emergency vehicle includes providing an AC power unit operating system comprising an electrical distribution panel; a variable frequency drive control unit operationally connected to the electrical distribution panel and having a first variable frequency drive and a second variable frequency drive; and a hydraulic power unit operationally connected to the variable frequency drive controller. The hydraulic power unit comprises a housing having a first electric motor and a second electric motor, with the first electric motor connected to the first variable frequency drive and the second electric motor connected to the second variable frequency drive. A first pump and valve assembly is operatively connected to the first electric motor and a second pump and valve assembly is operatively connected to the second electric motor. The method comprises transmitting a motor start command from the electrical distribution panel to at least one of the variable frequency drives. The variable frequency drive controller ramps up power to the selected motor to begin rotation of the motor to a predetermined operating speed in a predetermined amount of time.

An AC power unit operating system for an emergency vehicle comprises an electrical distribution panel including operating elements. A variable frequency controller is connected to the electrical distribution panel and comprises a first variable frequency drive and a second variable frequency drive. A hydraulic power unit is connected to the variable frequency drive controller. The hydraulic power unit comprises a housing having a first electric motor and a second electric motor. A first pump and valve assembly is connected to the first electric motor and a second pump and valve assembly is connected to the second electric motor.

### BRIEF DESCRIPTION OF THE DRAWINGS

The invention will be described with reference to the following drawing figures wherein like reference characters identify like parts throughout.

FIG. 1 is a schematic diagram of an electrical system of the invention; and

FIG. 2 is a schematic diagram of a hydraulic circuit incorporating features of the invention.

### DESCRIPTION OF THE PREFERRED EMBODIMENTS

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Additionally, all documents, such as, but not limited to, issued patents and patent applications, referred to herein are to be considered to be “incorporated by reference” in their entirety.

An exemplary AC power unit operating system incorporating features of the invention will first be described and then operation of the system will be described.

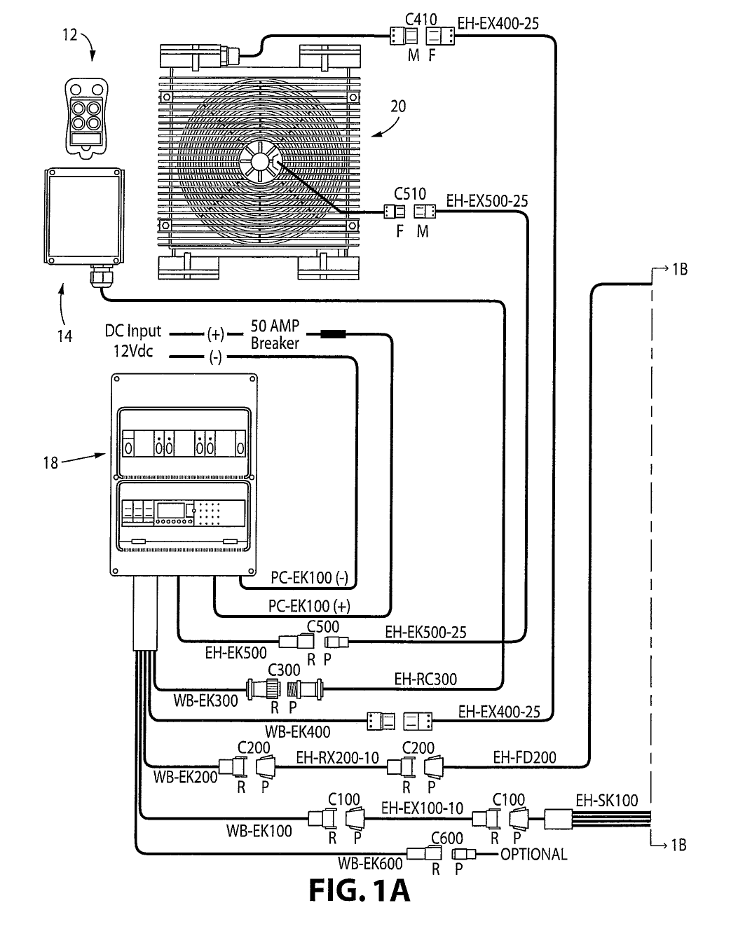

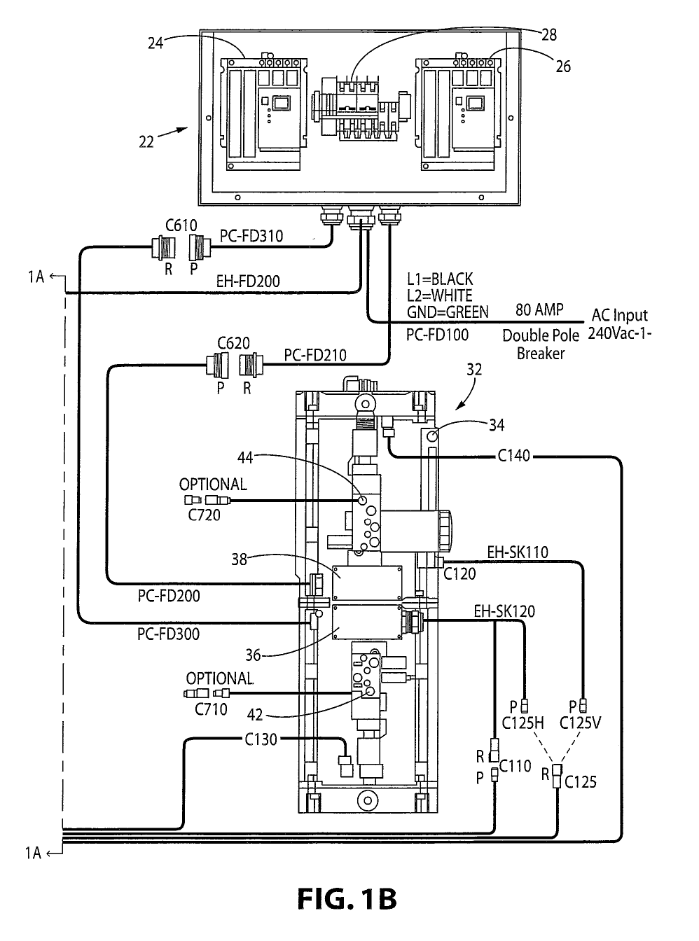

The electrical connection between the components of the system will first be described. As shown in FIG. 1, an operating system 10 of the invention can include a mobile controller 12, such as a hand-held radio transmitting unit. The mobile controller 12 can include operating elements, such as switches, push-buttons, and the like, to initiate various operations of the operating system 10. The mobile controller 12 can also include a display to display various system parameters, such as current operating pressures, motor status, valve status, and the like.

The operating system 10 can also include a radio receiver 14 to receive signals from the mobile controller 12. The radio receiver 14 is connected to a electrical distribution panel 18 having system operating controls, such as a master on/off switch, motor controllers for activation and deactivation of the hydraulic system motors, valve controllers for the opening and closing of various hydraulic valves, circuit breakers, warning lights, such as for hot oil or low oil, circuit breakers, and a micro-processer.

The electrical distribution panel 18 is operationally connected to a hydraulic fluid heat exchanger 20 having an electric motor driven fan to cool hydraulic fluid in the operating system. The electrical distribution panel 18 is also connected to a variable frequency drive control unit 22 having one or more variable frequency drives. In the illustrated embodiment, the drive control unit 22 has a first variable frequency drive 24, a second variable frequency drive 26, and a main bus bar 28. The main bus bar 28 includes electrical connectors and circuit breakers.

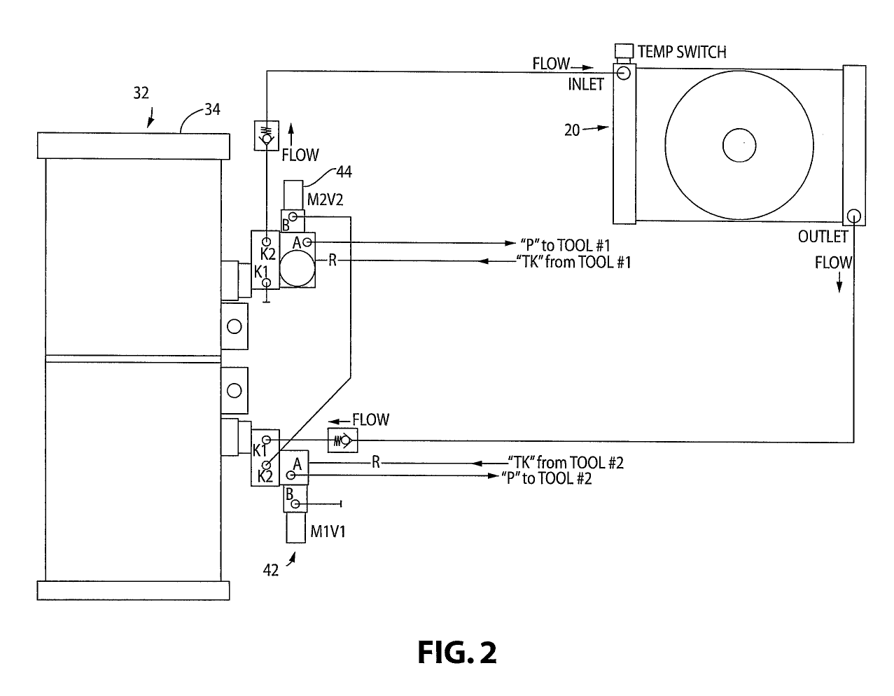

The variable frequency drive control unit 22 is connected to a hydraulic power unit 32. The hydraulic power unit 32 has a housing 34 and includes a plurality of electric motors in the housing 34. The electric motors are located within the housing 34. In the illustrated embodiment, there is a first electric motor 36 (connected to the first variable frequency drive 24) and a second electric motor 38 (connected to the second variable frequency drive 26). The housing 34 includes hydraulic fluid surrounding the internally mounted pumps, motors, and other components. The first electric motor 36 is operatively connected to a first pump and valve assembly 42 and the second electric motor 38 is operatively connected to a second pump and valve assembly 44. Hydraulic hoses can be connected to the hydraulic valves, as shown in FIG. 2. Hydraulic fluid in the housing 34 is transported via the pumps coupled to the electric motors and hydraulic valves into the hoses to operate hydraulic operated emergency tools. The electric motors, pumps, valves, and hoses can be configured to provide numerous flow rates dependent upon the desired operational characteristics of the tools used. For example, in one embodiment, the electric motors drive a piston group/eccentric that creates hydraulic oil flow up to about 10,150 pounds per square inch (psi) (700 bar) with differing flow rates. The unit can generate about 0.98 gallons per minute (GPM) up to 6,400 psi and then “step down” flow to about 0.64 GPM up to 10,150 psi. Of course, these flows, pressures, and step-downs can be configured in various other options.

Operation of the AC power unit operating system 10 will now be described. To start the first motor 36, a “start motor” button on the mobile controller 12 (or the appropriate start button at the electrical distribution panel 18) can be activated. The mobile controller 12 sends a signal to the radio receiver 14. The signal is transmitted to the micro-processer in the electrical distribution panel 18. However, unlike previous systems, the signal from the electrical distribution panel 18 is sent to the variable frequency drive control unit 22 rather than directly to a motor starter or relay. The first variable frequency drive 24 sends sine coded PWM 240 volt, three phase emulated power to the first motor 36 to start the motor turning. The first motor 36 begins to increase in speed and the speed ramps up to the normal operating speed for the motor. The time it takes to ramp up the motor speed can be selected and can be in the range of 0.1 seconds to 3600.0 seconds, such as 5 seconds. This eliminates the in-rush current problem. For a conventional electric motor operating at a speed of 1,700 rpm and 4 amps at no motor load, the highest current used during the start operation is about 4 amps, which equals the operating current of the motor when at full speed and, thus, no in-rush current spike is produced. Once the first motor 36 is at operating speed, the first valve assembly 42 can be opened to send hydraulic fluid from the housing 34 to the tool connected to the hydraulic hose attached to the first valve assembly 42.

Once the first motor 36 is operating, the second motor 38 can be started in a similar manner either using the mobile controller 12 or depressing the appropriate start button at the electrical distribution panel 18. The command to start the second motor 38 is transmitted from the electrical distribution panel 18 to the variable frequency drive control unit 22. The second variable frequency drive 26 slowly starts the second motor 38 turning and brings the second motor 38 up to operation speed in the predetermined amount of time. Again, since the motor is started using the variable frequency drive rather than simply sending current directly to a motor starter or relay, the in-rush current problem is overcome and all of the power of the AC generator can be used for operating equipment rather than requiring some of the generator capacity to remain unused to compensate for in-rush current in starting the electric motors.

If it is desirable to change one of the tools connected to the hydraulic circuit, one of the valve assemblies can be closed either using the mobile controller 12 or the electrical distribution panel 18. The associated electric motor continues to run. The tool is disconnected from the hydraulic hose using a quick disconnect coupling and a new tool is placed on the hose. The valve is then reopened to restore oil flow to the tool.

The oil temperature in the housing 34 can be monitored and, if the oil temperature rises above a predetermined temperature, returning hydraulic fluid from the emergency tools and valves 42 and 44 routed through the heat exchanger 20, as shown in FIG. 2, before returning to the housing 34 can be properly cooled by the control electrical distribution panel 18 operating the DC motor driven fan being part of the heat exchanger 20. This helps dissipate the heat load from operation of the emergency tools and the heat generated by the electric motors. Therefore, the electric motors do not require free air flow for cooling purposes.

The invention provides significant advantages over prior systems. For example, the hydraulic fluid in the housing not only powers the hydraulic tools but also provides cooling for the electric motors contained in the housing. Since no airflow is required to cool the electric motors, the hydraulic power unit can be mounted internally in the vehicle where there is no airflow and, therefore, does not take up other valuable storage space. Further, the system of the invention allows for the more efficient use of higher capacity output motors to provide greater operational power for the hydraulic tools.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. The method of operating an AC power unit operating system for an emergency vehicle, comprising the steps of:
providing an operating system comprising:
an electrical distribution panel;
a variable frequency drive control unit operationally connected to the electrical distribution panel and having a first variable frequency drive and a second variable frequency drive; and
a hydraulic power unit operationally connected to the variable frequency drive control unit, the hydraulic power unit comprising a housing having a first electric motor and a second electric motor, with the first electric motor connected to the first variable frequency drive and the second electric motor connected to the second variable frequency drive, and further comprising a first pump and valve assembly connected to the first electric motor and a second pump and valve assembly connected to the second electric motor,
transmitting a motor start command from the electrical distribution panel to at least one of the variable frequency drives; and
sending power from the variable frequency drive to the selected motor to begin rotation of the motor to a predetermined operating speed in a predetermined amount of time.

2. The method of claim 1, wherein the start command is manually input at the electrical distribution panel.

3. The method of claim 1, wherein the start command is initiated at a mobile controller in operational connection with a radio receiver, with the radio receiver connected to the electrical distribution panel.

4. The method of claim 1, further including sensing a temperature of the hydraulic fluid and cooling the hydraulic fluid by means of a hydraulic fluid heat exchanger when the temperature exceeds a predetermined limit.

5. An AC powered hydraulic system for an emergency vehicle, comprising:
an electrical distribution panel including operating elements;
a variable frequency control unit connected to the electrical distribution panel and comprising a first variable frequency drive and a second variable frequency drive;
a hydraulic power unit connected to the variable frequency drive controller, the hydraulic power unit comprising a housing having a first electric motor and a second electric motor, with a first pump and valve assembly connected to the first electric motor and a second pump and valve assembly connected to the second electric motor; and
a hydraulic fluid heat exchanger connected to the hydraulic power unit.

6. The system of claim 5, further including a radio receiver operatively connected to the electrical distribution panel and a mobile controller operatively connected to the radio receiver.
